(19) United States
(12) Patent Application Publication
(10) Pub. No.: US 2018/0032374 A1
(43) Pub. Date: Feb. 1, 2018

(54) APPLICATION LAUNCH BOOSTER

(71) Applicant: Intel Corporation, Santa Clara, CA (US)

(72) Inventor: MAHESH KUMAR P, Bangalore (IN)

(73) Assignee: Intel Corporation, Santa Clara, CA (US)

(21) Appl. No.: 15/225,567

(22) Filed: Aug. 1, 2016

(51) Int. Cl. G06F 9/50; G06F 1/32

(52) U.S. Cl. CPC G06F 9/5027; G06F 1/329

(57) ABSTRACT

The time required to launch an application may be reduced by increasing the performance of the system upon receiving an input indicative of a request to launch an application and decreasing the performance of the system upon receiving a notification that the Application has successfully launched. On Android® platforms, a PowerHAL wrapper layer may be created to generate an APP_LAUNCHER_START token upon receipt of the request to launch an application and an APP_LAUNCHER_COMPLETE token when the application has successfully launched. These tokens may be passed to a Generic Kernel Interface layer that increases system performance upon receipt of the APP_LAUNCHER_START token and reduced system performance upon receipt of the APP_LAUNCHER_COMPLETE token. A safety timer may be used to return the system to a lower performance state in the event the application fails to launch.

### TECHNICAL FIELD

The present disclosure relates improving the performance of an application load process.

### BACKGROUND

As mobile devices increasingly replace larger, less portable, devices for day-to-day activities such as sending and receiving email and text messages, streaming music, consuming media, browsing the Internet, and the like, proving a platform that optimizes response and enhances user experience becomes increasingly important. In fact, the benchmarks for mobile devices typically include “user experience” alongside other factors such as power and performance. Application launch time, as a measurable value that may be compared across platforms, provides an oft-considered factor in evaluating user experience. Generally, a quick application launch translates into a higher, or better, user experience evaluation. Improving application launch times on small form-factor or mobile devices is therefore of significant importance within the mobile device industry. Application launch time depends on a multitude of factors, such as stack optimization and system factors such as central processing unit (CPU), graphical processing unit (GPU) and memory bandwidth.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic diagram of an illustrative application launch system in which the transmission of an launch start token from an activity manager circuit to a power control circuit causes a system control circuit to transition the system from a first normal operating mode to a performance operating mode and in which the transmission of an launch complete token from an activity record circuit to the power control circuit causes the system control circuit to transition the system from the performance operating mode to a second normal operating mode, in accordance with at least one embodiment of the present disclosure;

FIG. 2 provides a schematic diagram of an illustrative application launch system in an Android® environment in which a PowerHAL wrapper communicates an “APP_LAUNCHER_START” token from an Activity Manager Service to a PowerHAL to transition the system from a first normal operating mode to a performance operating mode via a Generic Kernel Boost interface and also transmits a new “APP_LAUNCHER_COMPLETE” token to the PowerHAL to transition the system from the performance operating mode to a second normal operating mode via the Generic Kernel Boost interface, in accordance with at least one embodiment of the present disclosure;

FIG. 3 provides a schematic diagram of an illustrative application launch system similar to the system depicted in FIG. 1, with a safety timer that transitions the system from the performance operating mode to the first normal operating mode if one or more launch complete tokens are not received prior to the expiry of the safety timer, in accordance with at least one embodiment of the present disclosure.

FIG. 4 provides a schematic diagram of an illustrative safety timer implemented in an Android® PowerHAL, in accordance with at least one embodiment of the present disclosure; and

FIG. 5 provides a high-level logic flow diagram of an illustrative application launch method in which the transmission of an “APPLICATION LAUNCHER START” token from an Activity Manager Service to a PowerHAL Wrapper layer causes a added Generic Kernel Boost Interface to transition one or more devices from a first normal operating mode to a performance operating mode; and, in which the transmission of an “APPLICATION LAUNCHER COMPLETE” token from the Activity Manager Service to the PowerHAL Wrapper Layer causes the Generic Kernel Boost Interface to transition the one or more devices from the performance operating mode to a second normal operating mode, in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The systems and methods described herein decrease application launch times by tuning the bandwidth of the CPU, GPU, and memory hardware (i.e., system component bandwidth) to improve the launch time of an application that is initiated either manually by the system user (e.g., by selecting an icon displayed on the screen) or automatically by the system itself (e.g., automatically starting an Internet browser application when a user selects a Web link included in an email). Many current devices rely upon a dynamic voltage and frequency scaling (DVFS) mechanism of individual applications and/or operating systems to optimize system performance during application launches. However, the kernel frequency governors used to adjust the operating frequency of a virtual machine executing the application, the GPU displaying the application, and the memory hardware storing the application may not be able to respond in a timely manner to the application launch, which is a user space event, such that the application launch time is minimized to the greatest possible extent.

The Android application launch sequence includes receiving, at a Launcher, an input indicative of either a manual or automatic request to launch an application. In response, the Launcher generates a “StartActivity( )” call to the ActivityManagerService. The Android® “ActivityStack” and “ActivityStackSupervisor” servers trigger the application launch. The ActivityRecord receives a “WindowsVisible( )” call upon successful launch of the application. Thus, the “StartActivity( )” call to the ActivityManagerService and the “WindowsVisible( )” call to the ActivityRecord may be considered “bookends” that denote the respective initiation and completion of the application launch process.

The systems and methods described herein take advantage of the Android® Application Launch Boost Implementation that adds support to the Android® user space framework to extract application launch information and pass a hint to the device kernel indicative of an application launch event. The kernel is then able to control the CPU, GPU, and memory hardware impacted by the application launch in a manner that provides an optimal application launch based on the operational and performance limits of the device and/or application. Such a solution improves the application launch by taking hints from the user space and propagating the hints to the kernel governors thus making the governors and the system as a whole work in an energy efficient manner. As described herein, the entire implementation may be referred to as “App Launch Boost.”

The operating modes of individual system components, such as the CPU (that provides the virtual machine hosting the application), the GPU (that displays the application) and the memory hardware (that stores the application). The operating mode of each of these components is independently controlled using kernel/firmware governors. However, the governors do not directly receive an indication of an application launch event. Improving the intelligence of the governors to timely detect an application launch event provides the governors with the capability to improve component performance during the application launch process, thereby improving system performance, and beneficially increasing the quality of the user experience.

Increasing the operating frequency of the CPU, GPU, and/or memory hardware during the application launch process (e.g., locking the performance of these components to a maximum operating frequency) provides a significant improvement (i.e., reduction) in application launch time. The systems and methods described herein generate an application launch hint at the Android® Activity Manager Service level upon detecting an application launch. This hint is passed to the Android® PowerHAL. Responsive to receiving the application launch hint from the Android® Activity Manager Service level, the PowerHAL adjusts the governor settings of the CPU, GPU, and memory hardware such that some or all of these components operate in a maximum performance mode for the duration of the application launch. Upon successful launch of the application, an application launch successful hint is passed from the Activity Manager Service level to the PowerHAL. Responsive to receiving the application launch successful hint from the Android® Activity Manager Service level, the PowerHAL adjusts the governor settings of the CPU, GPU, and memory hardware back to the original level at which the respective component was operating prior to the application launch. To avoid extended operation of the CPU, GPU, and/or memory hardware at high power consumption, a safety timer implemented at the PowerHAL level may cause the PowerHAL to adjust or reset the governor settings of the CPU, GPU, and memory hardware back to the original level at which the respective component was operating prior to the application launch upon expiration of the safety timer.

Methods for improving the load time of an application on a mobile processor-based device are provided. Such methods may include: generating, by a power control circuit, at least one application launch token responsive to a launch request for an application; responsive to receipt of the at least one application launch token from the power control circuit, transitioning at least a portion of the system from a first normal operating mode to a performance operating mode in which a system control circuit adjusts one or more system parameters to decrease an application launch time relative to the application launch time in the first normal operating mode; generating, by the power control circuit, at least one application launch complete token indicative of a successful launch of the application; and responsive to receipt of the at least one application launch complete token, transitioning the at least a portion of the system from the performance operating mode to a second normal operating mode.

Systems for improving the load time of an application on a mobile processor-based device are provided. Such systems may include: a power control circuit; a system control circuit;

a storage device communicably coupled to the power control circuit and the system control circuit, the storage device including machine-readable instructions that, when executed: cause the power control circuit to generate at least one application launch token responsive to receipt of an application launch request for the application; cause the power control circuit to communicate the at least one application launch token to the system control circuit; responsive to receipt of the first message from the power control circuit, cause the system control circuit to transition at least a portion of the system from a first normal operating mode to a performance operating mode; cause the power control circuit to generate at least one application launch complete token indicative of a successful launch of the application; cause the power control circuit to communicate the at least one application launch complete token to the system control circuit; and cause the system control circuit to transition the at least a portion of the system from the performance operating mode to a second normal operating mode responsive to receipt of the at least one application launch complete token.

Additional systems for improving the load time of an application on a mobile processor-based device are also provided. Such systems may include: a means for generating at least one application launch token responsive to a launch request for an application; a means for transitioning at least a portion of the system from a first normal operating mode to a performance operating mode responsive to receipt of the at least one application launch token at a system control circuit; a means for generating at least one application launch complete token indicative of a successful launch of the application; and a means for transitioning the at least a portion of the system from the performance operating mode to a second normal operating mode responsive to receipt of the at least one application launch complete token at the system control circuit.

A storage device that includes machine-readable instructions that, when executed by a configurable circuit, transform the configurable circuit to a system control circuit is provided. The system control circuit to: cause a power control circuit to generate at least one application launch token responsive to a launch request for an application; transition at least a portion of the system from a first normal operating mode to a performance operating mode responsive to receipt of the at least one application launch token from the power control circuit; cause the power control circuit to at least one application launch complete token indicative of a successful launch of the application; and transition the portion of the system from the performance operating mode to a second normal operating mode responsive to receipt of the at least one application launch complete token.

As used herein, the terms “top,” “bottom,” “up,” “down,” “upward,” “downward,” “upwardly,” “downwardly” and similar directional terms should be understood in their relative and not absolute sense. Thus, a component described as being “upwardly displaced” may be considered “laterally displaced” if the device carrying the component is rotated 90 degrees and may be considered “downwardly displaced” if the device carrying the component is inverted. Such implementations should be considered as included within the scope of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

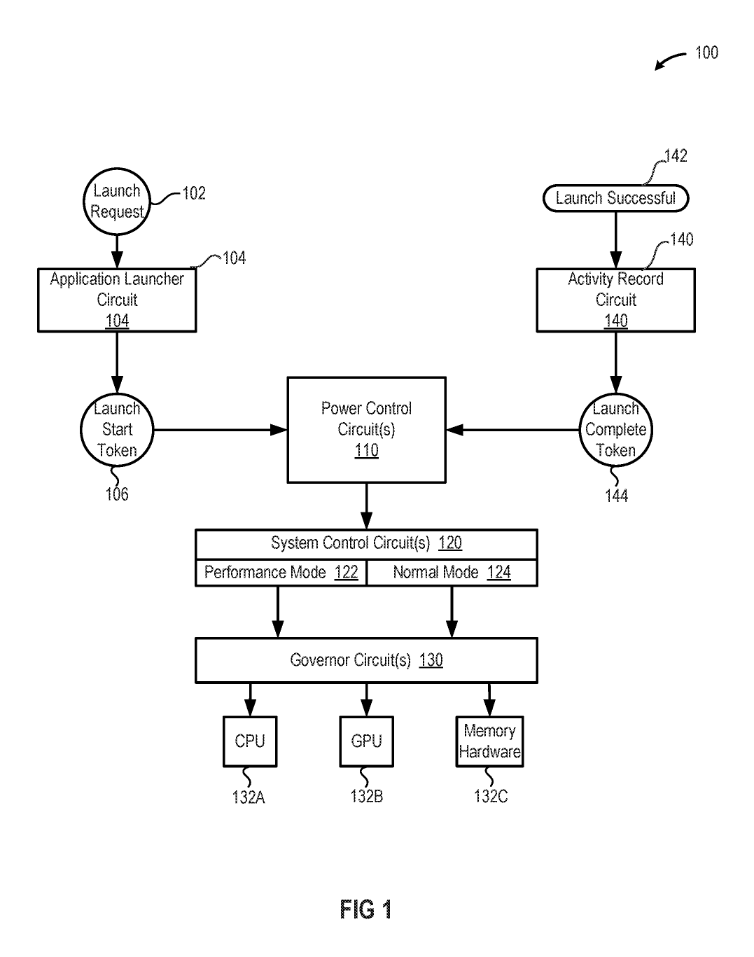

FIG. 1 is a schematic diagram of an illustrative application launch system 100 in which the transmission of an launch start token 106 from an activity manager circuit 104 to a power control circuit 110 causes a system control circuit 120 to transition the system 100 from a first normal operating mode to a performance operating mode and in which the transmission of an launch complete token 144 from an activity record circuit 140 to the power control circuit 110 causes the system control circuit 120 to transition the system 100 from the performance operating mode back to a second normal operating mode, in accordance with at least one embodiment of the present disclosure. The performance operating mode offers increased system performance at a higher energy consumption than either the first normal operating mode or the second normal operating mode. In some implementations, the power consumption and/or system configuration in the first normal operating mode may be the same as or different from the power consumption and/or system configuration in the second normal operating mode.

In embodiments, the application launch start token 106 provides a notification mechanism that beneficially enables the governor circuits 130 to increase and/or enhance the operation (e.g., operating frequency, bandwidth, resource availability) of any number of system components either prior to or very early in the launch process by placing those components in the performance operating mode. The benefit of the enhanced system performance is reflected in decreased application launch time and an enhanced user experience and/or satisfaction. In embodiments, the launch complete token 144 provides a notification mechanism that beneficially enables the governor circuits 130 to return the performance of the system components to the second normal operating mode subsequent to a successful launch of the application. Such a system is able to beneficially decrease both application launch time and power consumption by virtue of a significant reduction in application launch time. In benchtop testing, up to a 40% reduction in application launch time was observed.

An application launcher circuit 104 may receive an input 102 indicative of a request to launch an application. In some implementations, the input 102 may include a manual input indicative of a request to launch an application. An example manual input may include, but is not limited to, a user selecting an icon appearing on a touchscreen display device. Other such manual inputs may be received, for example, via a keyboard, pointing device, or similar manual entry device and/or system. In some implementations, the input 102 may include a system generated or autonomous input indicative of a request to launch an application. An example system generated or autonomous input may include, but is not limited to, an application launch request generated by the system in response to a user selecting an Internet URL received in an email.

Responsive to the receipt of the input, the application launcher circuit 104 may generate one or more launch start tokens 106. The one or more launch start tokens 106 may include information and/or data in the form of messages, or similar electronic data files. In some implementations, the one or more launch start tokens 106 may include information and/or data that is logically associated with and indicative of the requested application launch. In some implementations, the one or more launch start tokens 106 may be created by an intermediate device, logical structure, or circuit at the request of the application launcher circuit 104. The application launcher circuit 104 may generate the one or more launch start tokens 106 in addition to any other commands or messages typically generated and/or communicated by, to, or from the operating system during the application launch process.

Responsive to the receipt of the one or more launch start tokens 106, the power control circuit(s) 110 may communicate one or more application launch messages to a system control circuit(s) 120. The system control circuit(s) 120 may include any type, number, and/or combination of electrical and/or semiconductor devices capable of executing one or more sets of machine-readable instructions. In some implementations, the system control circuit(s) 130 may include one or more digital signal processors (DSPs), controllers, processors, single- or multi-core microprocessors, systems on a chip (SoC); application specific integrated circuit (ASIC); programmable gate array (PGA); reduced instruction set computer (RISC); hardwired electrical components and/or semiconductor devices; or any combination thereof.

The system control circuit(s) 130 may communicate one or more messages 122 to one or more governor circuit(s) 130. The one or more messages 122 include information and/or data instructing one or more system components 132A-132n (collectively, “components 132”) to enter the performance operating state to reduce the application launch time over the first normal operating state. In embodiments, the system control circuit(s) 120 communicate the one or more messages 122 to the one or more governor circuit(s) 130 responsive to the receipt of the one or more application launch messages from the power control circuit(s) 130.

In turn, the one or more governor circuit(s) 130 may cause one or more components 132 used in the application launch process to transition from the first normal operating state to the performance operating state. In the first normal operating state, system parameters are selected that balance system performance with system energy consumption to optimize battery life of the system 100. Such system parameters may include any number of energy consuming system parameters that include, but are not limited to, CPU clock speed and/or operating frequency; GPU clock speed and/or operating frequency; memory hardware (e.g., Random Access Memory) clock speed and/or operating frequency.

The performance operating mode may include one or more operating frequencies or one or more frequency bands or ranges that fall between the operating frequency in the first normal operating mode and the maximum permissible operating frequency of the system 100 and/or component 132. The performance operating mode may include an operating frequency at or about the maximum permissible operating frequency of the system 100 and/or component 132.

In some implementations, the system parameters associated with the performance operating mode may be autonomously selected by the governor circuit(s) 130 based on current system 100 bandwidth requirements, resource availability, and/or a priority assigned to the application being launched in relation to other applications either executing on or being launched on the system 100. In some implementations, the governor circuit(s) 130 may fix some or all of the system parameters while system 100 and/or devices 132 remain in the performance operating mode. In some implementations, the governor circuit(s) 130 may alter, control, and/or adjust some or all of the system parameters while the system 100 and/or devices 132 remain in the performance operating mode.

In some implementations, the governor circuit(s) 130 may alter, control, and/or adjust one or more operating parameters (e.g., clock speed) of one or more central processing units (CPUs) 132A associated with the application launch process. For example, the governor circuit(s) 130 may increase the operating frequency of the CPU 132A that hosts or otherwise provides a virtual machine (VM) on which the application is launched and executed for the duration of the application launch process.

In some implementations, the governor circuit(s) 130 may alter, control, and/or adjust one or more operating parameters (e.g., clock speed) of one or more system, circuits, or components 132B associated with generating the graphical output provided by the launched application. For example, the governor circuit(s) 130 may increase the operating frequency of a graphical processing unit (GPU) 132B responsible for providing the graphical output generated by the launched application.

In some implementations, the governor circuit(s) 130 may alter, control, and/or adjust one or more operating parameters of memory hardware (e.g., Random Access Memory), systems, or devices 132C associated with storing at least a portion of the instructions and/or data associated with or used by the launched application. For example, the governor circuit(s) 130 may increase the operating frequency of a memory block 132C responsible for providing at least a portion of the storage for instructions and/or data associated with the launched application.

In embodiments, the governor circuit(s) 130 may maintain the system components and/or resources used in launching the application for the duration of the application launch, for example until a window associated with the application is presented to the system user via a display device communicably coupled to the system 100.

An activity record circuit 140 may receive one or more application active notifications 142 responsive to a successful launch of the application. In embodiments, the one or more application active notifications 142 may be communicated to the activity record circuit 140 by the one or more system control circuits 120. In other embodiments, such application active notifications 142 may be communicated by the one or more CPUs 132A associated with VM on which the application is executing. In some implementations, the one or more application active notifications 142 may be communicated upon the occurrence of one or more events indicative of a successful application launch. For example, upon the occurrence of one or more windows logically associated with at least a portion of the application opening on a display device communicably coupled to the system 100.

The activity record circuit 140 may communicate one or more application launch complete tokens, messages, or similar electronic data files 144 (hereinafter, “launch complete tokens 144”) to the power control circuit(s) 110 responsive to receiving the one or more application active notifications 142. The one or more launch complete tokens 144 may include information indicative of a successfully completed launch of the application. In some implementations, the one or more launch complete tokens 144 may be created by an intermediate device, logical structure, or circuit at the request of the activity record circuit 140. Responsive to the receipt of the one or more launch complete tokens 144, the power control circuit(s) 110 may communicate one or more application launch complete messages to the system control circuit(s) 130. The activity record circuit 140 may generate the one or more launch complete tokens 144 in addition to any other commands or messages typically generated and/or communicated by, to, or from the operating system during the application launch process.

The system control circuit(s) 130 may communicate a return to normal operating mode message 124 to one or more governor circuit(s) 130 responsive to the receipt of the one or more application launch complete messages from the power control circuit(s) 130. In turn, the one or more governor circuit(s) 130 may transition the one or more system components currently in the performance operating mode from the performance operating mode to a second normal operating mode. In some implementations, the second normal operating mode may include system parameters that are the same as the first normal operating mode (e.g., the operating frequency in the second normal operating mode is the same as the operating frequency in the first normal operating mode). In other implementations, the second normal operating mode may include one or more system parameters that differ from the first normal operating (e.g., the operating frequency in the second normal operating mode differs from the operating frequency in the first normal operating mode).

In some implementations, one or more system parameters in the second normal operating mode may be autonomously selected by the governor circuit(s) 130 based on current system 100 bandwidth requirements, resource availability, and/or a priority assigned to the application being launched in relation to other applications either executing on or being launched on the system 100. For example, the system control circuit(s) 120 may select one or more system parameters in the second normal operating mode based, at least in part, on the expected resource usage of the recently launched application. In some implementations, the governor circuit(s) 130 may vary some or all of the system operating parameters in the second normal operating mode, for example responsive to the resource demands of other applications executing on the system 100.

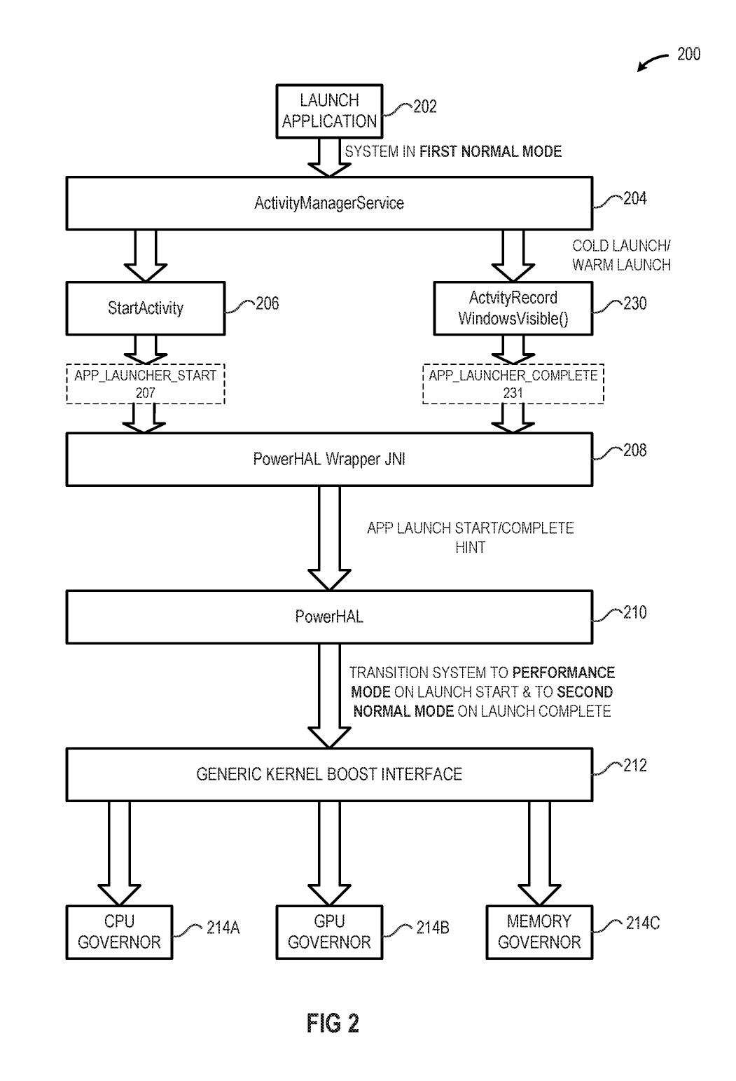

FIG. 2 provides a schematic diagram of an illustrative application launch system 200 in an Android® environment in which a new PowerHAL wrapper 210 communicates a new “APP_LAUNCHER_START” token 207 from an Activity Manager Service 204 to a PowerHAL 210 to transition the system 200 from a first normal operating mode to a performance operating mode via a newly added generic kernel boost interface 212 and also transmits a new “APP_LAUNCHER_COMPLETE” token 231 to the PowerHAL 210 to transition the system from the performance operating mode to a second normal operating mode via the newly added generic kernel boost interface 212, in accordance with at least one embodiment of the present disclosure.

The APP_LAUNCHER_START token 207 and the APP_LAUNCHER_COMPLETE token 231 are added to the PowerHAL 210 and the Android® server library. The Android® server library may be modified to pass these hints to the hardware abstraction layer (HAL) at the start of an application launch (e.g., upon receipt of the StartActivity( ) call 206 by the Activity Manager Service 204) and at the completion of the application launch (e.g., upon receipt of the WindowsVisible( ) call by the ActivityRecord 230). The Android® server layer may be further modified through the addition of a new PowerHAL wrapper layer 208. The PowerHAL wrapper layer 208 may cause the Android® server to pass an APP_LAUNCHER_START token 207 to the PowerHAL 210 upon receipt of the StartActivity( ) call 206. The PowerHAL wrapper layer 208 may further cause the Android® server to pass an APP_LAUNCHER_COMPLETE token 231 to the PowerHAL 210 upon receipt of the WindowsVisible( ) call.

In embodiments, the system 200 may be in a first normal operating state in which system performance is balanced against energy consumption to provide both an acceptable system response and an acceptable system battery life. Upon receipt of an input 202 indicative of a request to launch an application, the ActivityManagerService 204 generates the StartActivity( ) call 206. The StartActivity( ) call 206 marks the commencement of the application launch process and triggers the transmission of the APP_LAUNCHER_START token 207 from the Android® server to the PowerHAL Wrapper layer 208. The PowerHAL Wrapper layer 208 may be implemented in the Java® native interface layer (JNI). The PowerHAL Wrapper layer 208 passes the APP_LAUNCHER_START token 207 to the PowerHAL 210.

Upon receipt of the APP LAUNCHER START token 207, the PowerHAL transitions at least some of one or more central processing unit governors 214A, one or more graphical processing unit governors 214B, and/or one or more memory hardware governors 214C (collectively, “governors 214”) from the first normal operating mode to the performance operating mode. Once placed in the performance operating mode, the time required to launch an application is minimized at the expense of an increase in system power consumption. However, a shortened launch process at a relatively high energy consumption has been found more efficient than an extended launch process at a relatively low energy consumption. Each of the one or more governors 214 may expose an interface in the form of sysfs to enable the HAL containing PowerHAL 210 to interface with the one or more governors 214. To improve the cross-platform reliability of the system 200 by making the implementation platform governor independent, a single generic kernel boost interface 212 between the PowerHAL 210 and each of the governors 214 may be implemented in the system kernel.

In embodiments, the generic kernel boost interface 212 may concurrently transition some or all of the one or more governors 214 from the first normal operating mode to the performance operating mode. Such concurrent transitioning beneficially assists in permitting a single sysfs write from the HAL to switch the one or more governors 214 to the performance operating mode. Since the PowerHAL 210 need not know the specific characteristics of the underlying kernel governor (thereby permitting a generic HAL implementation), the use of the generic kernel boost interface 212 advantageously facilitates the future addition of other governors 214 in addition to the three listed in FIG. 2.

Upon completion of the application launch, the ActivityRecord layer 230 may pass the APP_LAUNCHER_COMPLETE token 231 to the PowerHAL wrapper 208. The PowerHAL wrapper 208 passes the APP_LAUNCHER_COMPLETE token 231 to the HAL and consequently to the PowerHAL 210. The PowerHAL 210 may then write to the generic kernel boost interface 212 an instruction to transition all of the one or more governors 214 in the performance operating mode to a second normal operating mode.

In addition, the implementation of the APP LAUNCHER START token 207 and the APP_LAUNCHER_COMPLETE token 231 in conjunction with the PowerHAL wrapper 208 and the generic kernel boost interface 212 may be incorporated into both fresh application launches (i.e., a “cold” launch) and existing applications operating in the background (i.e., a “warm” launch). Further, such an implementation may accommodate future installed applications which receive the benefit of increased system performance during the application launch process. This is achieved by implementing the enhanced performance during app launch at the framework layer and not at the application layer, thereby making the performance enhancements generic and available to all applications installed across the system 200. Furthermore, system 200 beneficially remains in the enhanced performance state throughout the application launch process, thereby achieving maximum energy efficiency during application launch.

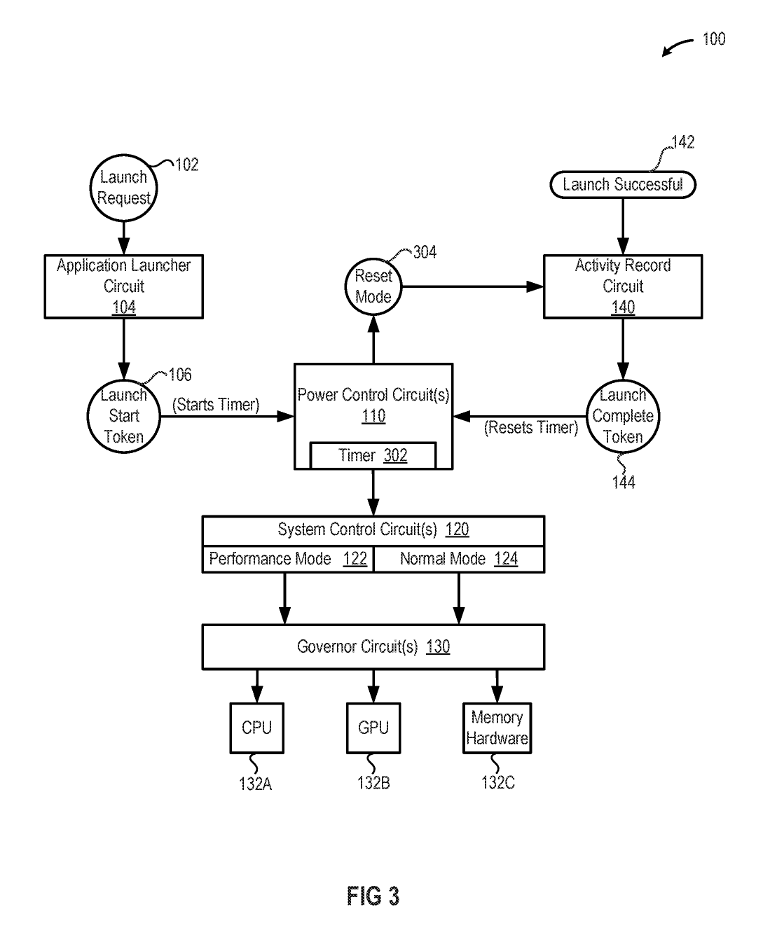

FIG. 3 provides a schematic diagram of an illustrative application launch system 300 similar to the system 100 depicted in FIG. 1, with a safety timer 302 that transitions the system 300 from the performance operating mode to the first normal operating mode if one or more launch complete tokens 144 are not received prior to the expiry of the safety timer 302, in accordance with at least one embodiment of the present disclosure. In some implementations, one or more timers 302 may be implemented within the power control circuit(s) 110. In such an implementation, receipt of the one or more launch start tokens 106 by the power control circuit(s) 110 may initialize, start, or otherwise commence the one or more timers 302. In some implementations, the one or more timers 302 may include one or more count-up timers having a defined elapsed time threshold value (5 seconds, 10 seconds, 15 seconds, 20 seconds, 30 seconds, etc.). In some implementations, the one or more timers 302 may include one or more count-down timers having a defined start time value (5 seconds, 10 seconds, 15 seconds, 20 seconds, 30 seconds, etc.).

Receipt of the one or more launch complete tokens 144 by the power control circuit(s) 110 may halt and reset the safety timer 302. In embodiments, if the power control circuit(s) 110 receive the one or more launch complete tokens prior to the expiry of the safety timer 302, the system control circuit(s) 120 cause the governor circuit(s) to transition some or all of the devices 132 from the performance operating mode to a second normal operating mode. In some implementations, the second normal operating mode may include one or more system parameters (e.g., increased memory allocation) useful to the launched application.

In embodiments, if the power control circuit(s) 110 fail to receive the one or more launch complete tokens prior to the expiry of the safety timer 302, the power control circuit(s) 110 may communicate one or more “reset mode” tokens 304 to the activity record circuit 140. The power control circuit(s) 110 may then cause the governor circuit(s) 130 to transition at least some of the devices 132 from the performance operating mode to the first normal operating mode (i.e., the system operating mode prior to receiving the one or more launch start tokens 106.

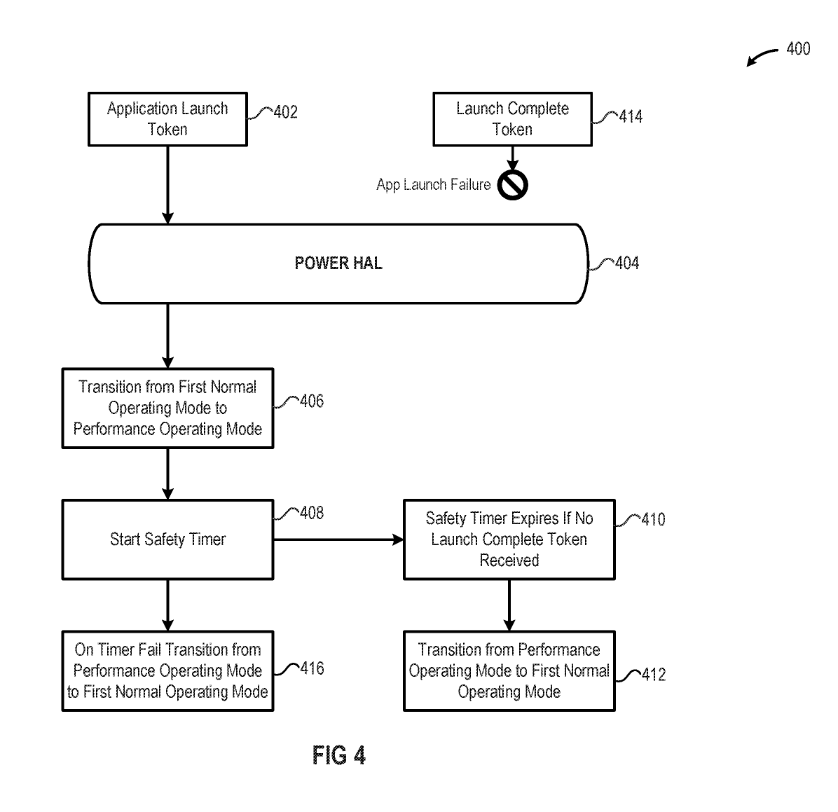

FIG. 4 provides a schematic diagram of an illustrative safety timer 400 implemented in an Android® PowerHAL, in accordance with at least one embodiment of the present disclosure. An application launch token 402 may be received at the PowerHAL 404 responsive to receipt of an application launch request.

At 406, the PowerHAL 404 causes the governor to transition one or more devices 132 from the first normal operating mode to a performance operating mode responsive to receipt of the application launch token 402. At 408, the PowerHAL 404 initiates, starts, or otherwise commences the safety timer 302.

At 410, the PowerHAL 404 fails to receive the application launch complete token prior to the expiry of the safety timer 302. Such a scenario may occur for a multitude of reasons. For example, the application may crash during the launch process or the device user may abort the application launch prior to completion.

At 412, responsive to the failure to receive the application launch complete token 414 prior to the expiry of the safety timer 302, the PowerHAL 404 causes the governor circuit(s) 130 to transition the devices 132 from the performance operating state to the first normal operating state. Returning to the first normal operating state may provide greater stability assuming the system was in a stable operating state when in the first normal operating state.

At 416, in the event the safety timer 302 fails, the PowerHAL 404 may cause the governor circuit(s) 130 to transition the devices 132 from the performance operating state to a first normal operating state. Returning to the first normal operating state may provide greater stability assuming the system was in a stable operating state when in the first normal operating state.

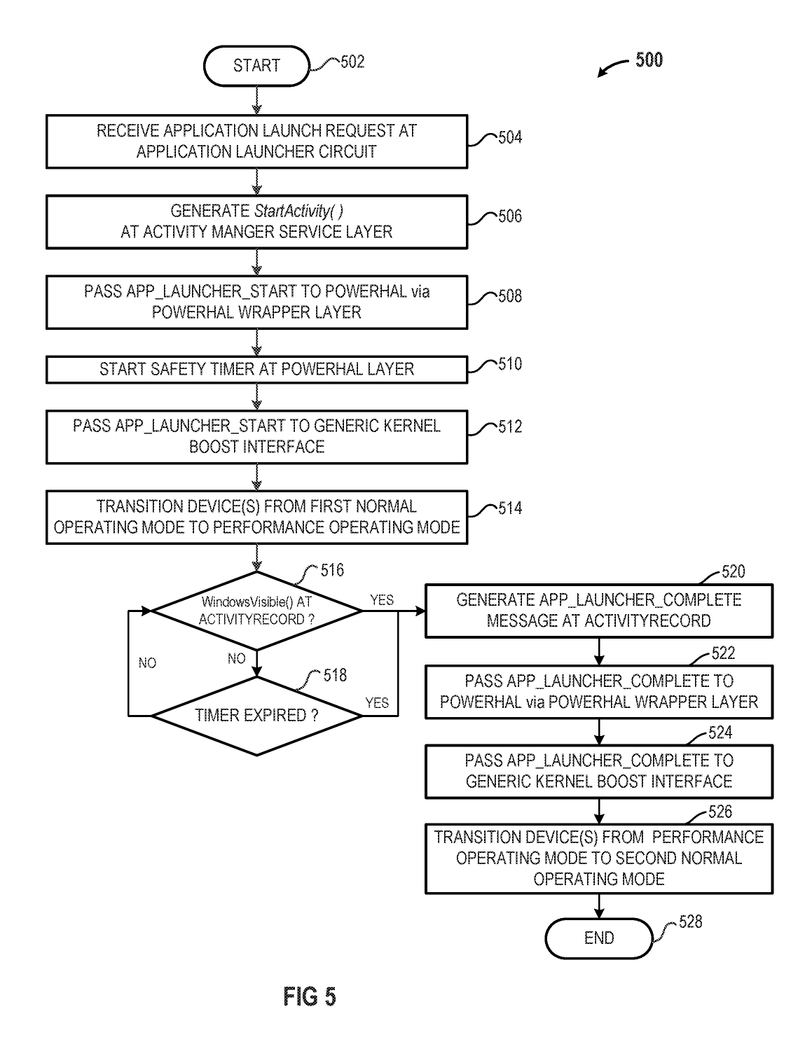

FIG. 5 provides a high-level logic flow diagram of an illustrative application launch method 500 in which the transmission of an “APPLICATION LAUNCHER START” token 207 from an Activity Manager Service 204 to a newly added PowerHAL Wrapper layer 208 causes a newly added Generic Kernel Boost Interface 212 to transition one or more devices 132 from a first normal operating mode to a performance operating mode; and, in which the transmission of an “APPLICATION LAUNCHER COMPLETE” token 231 from the Activity Manager Service 204 to the PowerHAL Wrapper Layer 208 causes the Generic Kernel Boost Interface 212 to transition the one or more devices 132 from the performance operating mode to a second normal operating mode, in accordance with at least one embodiment of the present disclosure. The method 500 commences at 502.

At 504, an application launcher circuit receives an input indicative of an application launch request. In some embodiments, the input may include one or more manual inputs. For example, a touchscreen input selecting an icon associated with executing one or more specific applications. In other embodiments, the input may include one or more autonomous or automatic inputs. For example, one or more inputs generated by the system responsive to a system user selecting a URL embedded in an email.

At 506, an ACTIVITYSERVICEMANAGER generates a StartActivity( ) call indicative of the selected application launch request. The StartActivity( ) call may trigger the generation of an APP_LAUNCHER_START token 207.

At 508, a PowerHAL Wrapper layer 208 may pass or otherwise communicate the APP_LAUNCHER_START token 207 to a PowerHAL layer 210.

At 510, the PowerHAL layer 210 starts at least one safety timer 302. The at least one safety timer will prevent the devices 132 from remaining in the high power demand performance operating mode for an extended period. The safety timer 302 may commence concurrent with th receipt of the APP_LAUNCHER_START token 207 by the PowerHAL layer 210.

At 512, the PowerHAL layer 210 communicates the APP_LAUNCHER_START token 207 to the Generic Kernel Boost Interface 212. At 514, responsive to the receipt of the APP_LAUNCHER_START token 207 at 512, the

Generic Kernel Boost Interface 212 transitions at least one device 132 from a first normal operating mode to a performance operating mode. The at least one device 132 remains in the performance operating mode for the duration of the application launch process or until the safety timer reaches a defined threshold value (e.g., 15 seconds for a count-up timer, 0 seconds for a count-down timer).

At 516 the PowerHAL Wrapper layer 208 determines whether the ACTIVITYRECORD 230 has received a WindowsVisisble( ) call. The WindowsVisible( ) call indicates a successful launch of the selected application. If the WindowsVisible( ) call has NOT been received by the ACTIVITYRECORD 230, at 518 the PowerHAL wrapper layer determines whether the safety timer 302 has expired. If the safety timer has not expired, the PowerHAL Wrapper layer 208 continues to determine whether the ACTIVITYRECORD 230 has received a WindowsVisisble( ) call at 516.

If the 516 the PowerHAL Wrapper layer 208 determines the ACTIVITYRECORD 230 has received a WindowsVisisble( )call or if the safety timer has expired at 518, the method 500 continues at 520.

At 520, the ACTIVITYRECORD 230 generates an APP_LAUNCHER_COMPLETE token 231.

At 522, the PowerHAL wrapper layer 208 passes the APP_LAUNCHER_COMPLETE token 231 to the PowerHAL 210.

At 524, the PowerHAL 210 communicates the APP_LAUNCHER_COMPLETE token 231 to the Generic Kernel Boost Interface 212.

At 526, the Generic Kernel Boost Interface 212 transitions the at least one device 132 from the performance operating mode to a second normal operating mode. In some implementations, the system parameters associated with the second normal operating mode may be similar or identical to the system operating parameters associated with the first normal operating mode. In other implementations, the system operating parameters associated with the second normal operating mode may differ from the system operating parameters associated with the first normal operating mode. The method 500 concludes at 528.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. The following examples of the present disclosure may comprise subject material such as a device, a method, means for performing acts based on the method and/or a system for improving the performance of an application launch on a mobile device. Such systems and methods advantageously and beneficially facilitate an improved user experience as well as reducing overall power consumption of the mobile device.

According to example 1, there is provided a method for improving the load time of an application on a mobile processor-based device. The method may include: generating, by a power control circuit, at least one application launch token responsive to a launch request for an application; responsive to receipt of the at least one application launch token from the power control circuit, transitioning at least a portion of the system from a first normal operating mode to a performance operating mode in which a system control circuit adjusts one or more system parameters to decrease an application launch time relative to the application launch time in the first normal operating mode; generating, by the power control circuit, at least one application launch complete token indicative of a successful launch of the application; and responsive to receipt of the at least one application launch complete token, transitioning the at least a portion of the system from the performance operating mode to a second normal operating mode.

Example 2 may include elements of example 1 where transitioning at least a portion of the system from a first normal operating mode to a performance operating mode may include increasing, by the system control circuit, an operating frequency from a first operating frequency to a second operating frequency of at least one of: a virtual machine to execute the application; a graphical processing unit (GPU) to generate a display output for the application; or a memory device that includes at least one of instructions or data used by the application.

Example 3 may include elements of example 2 where transitioning the at least a portion of the system from the performance operating mode to a second normal operating mode may include decreasing the operating frequency of the at least one of: the virtual machine; the GPU; or the memory hardware from the second frequency to a third frequency by the system control circuit.

Example 4 may include elements of example 3, and the method may additionally include initiating, by the power control circuit, at least one timer having at least a first defined temporal threshold; and, responsive to a failure to generate the at least one application launch complete token prior to the at least one timer reaching the first defined temporal threshold, transitioning the at least a portion of the system from the performance operating mode to the first normal operating mode.

Example 5 may include elements of example 4 where transitioning the at least a portion of the system from the performance operating mode to a first normal operating mode may include generating, by the power control circuit, a message that causes the system control circuit to decrease the operating frequency of at least one of: the virtual machine; the GPU; or the memory hardware from the second frequency to the first frequency.

Example 6 may include elements of example 4 where initiating by the power control circuit at least one timer may include initiating the at least one timer contemporaneous with the generation of the at least one application launch token by the power control circuit.

Example 7 may include elements of example 1 where generating at least one application launch token may include receiving a first input at an activity manager circuit, the input indicative of a request to launch the application; generating, by the activity manager circuit, an application launch message responsive to receipt of the first input; and communicating the application launch message to the power control circuit.

Example 8 may include elements of example 7 where generating an application launch message responsive to receipt of the input indicative of the request to launch the application may include generating a StartActivity( ) message by an ActivityManagerService responsive to receipt of the first input.

Example 9 may include elements of example 8 where generating, by a power control circuit, at least one application launch token responsive to a launch request for an application may include generating, by a powerHAL wrapper layer the at least one application launch token; communicating the at least one application launch token to a powerHAL layer; generating an application launch message at the powerHAL layer; and communicating the application launch message to a Linux kernel.

Example 10 may include elements of example 9 where transitioning at least a portion of the system from a first normal operating mode to a performance operating mode in which a system control circuit adjusts one or more system parameters to decrease an application launch time relative to the application launch time in the first normal operating mode may include responsive to receipt of the application launch message at the Linux kernel, causing one or more kernel governors to increase an operating frequency from a first frequency to a second frequency of at least one of: a virtual machine to execute the application; a graphical processing unit (GPU) to generate a display output for the application; or a memory hardware that includes at least one of instructions or data used by the application.

Example 11 may include elements of example 7 where generating, by the power control circuit, at least one application launch complete token may include receiving a second input at an activity manager circuit indicative that the application has successfully launched; generating, by the activity manager circuit, an application successful message responsive to receipt of the second input; and communicating the application successful message to the power control circuit.

Example 12 may include elements of example 11 where generating, by the activity manager circuit, an application successful message responsive to receipt of the second input may include generating, by an ActivityManagerService, a WindowsVisible( ) message responsive to receipt of the second input.

Example 13 may include elements of example 12 where generating, by the power control circuit, at least one application launch complete token may include: generating, by a powerHAL wrapper layer the at least one successful launch token; communicating the at least one successful launch token to a powerHAL layer; generating a successful launch message at the powerHAL layer; and communicating the successful launch message to a Linux kernel.

Example 14 may include elements of example 13 where communicating the successful launch message to the Linux kernel may further include causing one or more kernel governors to transition at least a portion of the system from the performance operating mode to the second normal operating mode

Example 15 may include elements of example 1 where transitioning the at least a portion of the system from the performance operating mode to a second normal operating mode may include transitioning the at least a portion of the system from the performance operating mode to a second normal operating mode, the second normal operating mode the same as the first normal operating mode.

According to example 16, there is provided a system for improving the load time of an application, the system comprising: a power control circuit; a system control circuit; a storage device communicably coupled to the power control circuit and the system control circuit, the storage device including machine-readable instructions that, when executed: cause the power control circuit to generate at least one application launch token responsive to receipt of an application launch request for the application; cause the power control circuit to communicate the at least one application launch token to the system control circuit; responsive to receipt of the first message from the power control circuit, cause the system control circuit to transition at least a portion of the system from a first normal operating mode to a performance operating mode; cause the power control circuit to generate at least one application launch complete token indicative of a successful launch of the application; cause the power control circuit to communicate the at least one application launch complete token to the system control circuit; and cause the system control circuit to transition the at least a portion of the system from the performance operating mode to a second normal operating mode responsive to receipt of the at least one application launch complete token.

Example 17 may include elements of example 16 where the machine-readable instructions that cause the system control circuit to transition at least a portion of the system from a first normal operating mode to a performance operating mode may further cause the system control circuit to: increase an operating frequency from a first operating frequency to a second operating frequency of at least one of: a virtual machine to execute the application; a graphical processing unit (GPU) to generate a display output for the application; or a memory device that includes at least one of instructions or data used by the application.

Example 18 may include elements of example 17 where the machine-readable instructions that cause the system control circuit to transition the at least a portion of the system from the performance operating mode to the second normal operating mode may further cause the system control circuit to: decrease the operating frequency of the at least one of: the virtual machine; the GPU; or the memory hardware from the second frequency to a third frequency by the system control circuit.

Example 19 may include elements of example 18 where the machine-readable instructions may further: cause the power control circuit to initiate at least one timer having at least a first defined temporal threshold; and responsive to a failure to generate the at least one application launch complete token prior to the at least one timer reaching the first defined temporal threshold, cause the system control circuit to transition the at least a portion of the system from the performance operating mode to the first normal operating mode.

Example 20 may include elements of example 19 where the machine-readable instructions that cause the system control circuit to transition the at least a portion of the system from the performance operating mode to the first normal operating mode may further cause the system control circuit to decrease the operating frequency of at least one of: the virtual machine; the GPU; or the memory hardware from the second frequency to the first frequency.

Example 21 may include elements of example 19 where the machine-readable instructions that cause the power control circuit to initiate at least one timer may further cause the power control circuit to initiate the at least one timer contemporaneous with the generation of the application launch token.

Example 22 may include elements of example 16 where the machine-readable instructions that cause the power control circuit to generate at least one application launch token may cause the power control circuit to: receive a first input indicative of a request to launch the application at an activity manager circuit; cause the activity manager circuit to generate an application launch message responsive to receipt of the first input; and cause the activity manager circuit to communicate the application launch message to the power control circuit.

Example 23 may include elements of example 22 where the machine-readable instructions that cause the activity manager circuit to generate an application launch message may cause the activity manager circuit to: cause an ActivityManagerService to generate a StartActivity( ) message responsive to receipt of the first input.

Example 24 may include elements of example 23 where the machine-readable instructions that cause the power control circuit to generate at least one application launch token cause the power control circuit to: cause a powerHAL wrapper layer to generate the at least one application launch token; cause the powerHAL wrapper layer to communicate the at least one application launch token to a powerHAL layer; cause the powerHAL layer to generate an application launch message; and cause the powerHAL layer to communicate the application launch message to a Linux kernel.

Example 25 may include elements of example 24 where the machine-readable instructions that cause the system control circuit to transition at least a portion of the system from a first normal operating mode to a performance operating mode may further cause the system control circuit to: cause one or more kernel governors to increase the operating frequency from the first operating frequency to the second operating frequency responsive to receipt of the application launch message at the Linux kernel.

Example 26 may include elements of example 22 where the machine-readable instructions that cause the power control circuit to generate at least one application launch complete token may cause the power control circuit to: cause the activity manager circuit to generate an application successful message responsive to receipt of a second input indicative that the application has successfully launched; and cause the activity manager circuit to communicate the application successful message to the power control circuit.

Example 27 may include elements of example 26 where the machine-readable instructions that cause the activity manager circuit to generate an application successful message may cause the activity manager circuit to: cause an ActivityManagerService to generate a WindowsVisible( ) message responsive to receipt of the second input.

Example 28 may include elements of example 22 where the machine-readable instructions that cause the power control circuit to generate at least one application launch complete token may cause the power control circuit to: cause a powerHAL wrapper layer to generate the at least one successful launch token; cause the powerHAL wrapper layer to communicate the at least one successful launch token to a powerHAL layer; cause the powerHAL layer to generate a successful launch message; and cause the powerHAL layer to communicate the successful launch message to a Linux kernel.

Example 29 may include elements of example 28 where the machine-readable instructions that cause the system control circuit to transition the at least a portion of the system from the performance operating mode to a second normal operating mode may further cause the system control circuit to: cause one or more kernel governors to decrease the operating frequency from the second operating frequency to the operating third frequency responsive to receipt of the successful launch message by the Linux kernel.

According to example 30, there is provided a system for improving application load time performance of a processor-based device. The system may include: a means for generating at least one application launch token responsive to a launch request for an application; a means for transitioning at least a portion of the system from a first normal operating mode to a performance operating mode responsive to receipt of the at least one application launch token at a system control circuit; a means for generating at least one application launch complete token indicative of a successful launch of the application; and a means for transitioning the at least a portion of the system from the performance operating mode to a second normal operating mode responsive to receipt of the at least one application launch complete token at the system control circuit.

Example 31 may include elements of example 30 where the means for transitioning at least a portion of the system from a first normal operating mode to a performance operating mode may include a means for increasing an operating frequency from a first operating frequency to a second operating frequency of at least one of: a virtual machine to execute the application; a graphical processing unit (GPU) to generate a display output for the application; or a memory device that includes at least one of instructions or data used by the application.

Example 32 may include elements of example 31 where the means for transitioning the at least a portion of the system from the performance operating mode to a second normal operating mode may include: a means for decreasing the operating frequency of the at least one of: the virtual machine; the GPU; or the memory hardware from the second frequency to a third frequency.

Example 33 may include elements of example 32, and the system may additionally include: a means for initiating at least one timer having at least a first defined temporal threshold; and a means for transitioning the at least a portion of the system from the performance operating mode to the first normal operating mode responsive to a failure to generate the at least one application launch complete token prior to the at least one timer reaching the first defined temporal threshold.

Example 34 may include elements of example 32 where the means for transitioning the at least a portion of the system from the performance operating mode to a first normal operating mode may include a means for generating a message that causes the system control circuit to decrease the operating frequency of at least one of: the virtual machine; the GPU; or the memory hardware from the second frequency to the first frequency.

Example 35 may include elements of example 33 where the means for initiating at least one timer may include: a means for initiating the at least one timer contemporaneous with the generation of the at least one application launch token by the power control circuit.

Example 36 may include elements of example 30 where the means for generating at least one application launch token may include: a means for receiving a first input at an activity manager circuit, the input indicative of a request to launch the application; a means for generating an application launch message responsive to receipt of the first input; and a means for communicating the application launch message to the power control circuit.

Example 37 may include elements of example 36 where the means for generating an application launch message responsive to receipt of the input indicative of the request to launch the application may include a means for generating a StartActivity( ) message by an ActivityManagerService responsive to receipt of the first input.

Example 38 may include elements of example 36 where the means for generating, by a power control circuit, at least one application launch token responsive to a launch request for an application may include a means for generating, by a powerHAL wrapper layer the at least one application launch token; a means for communicating the at least one application launch token to a powerHAL layer; a means for generating an application launch message at the powerHAL layer; and a means for communicating the application launch message to a Linux kernel.

Example 39 may include elements of example 38 where the means for transitioning at least a portion of the system from a first normal operating mode to a performance operating mode in which a system control circuit adjusts one or more system parameters to decrease an application launch time relative to the application launch time in the first normal operating mode may include: a means for responsive to receipt of the application launch message at the Linux kernel, causing one or more kernel governors to increase an operating frequency from a first frequency to a second frequency of at least one of: a virtual machine to execute the application; a graphical processing unit (GPU) to generate a display output for the application; or a memory hardware that includes at least one of instructions or data used by the application.

Example 40 may include elements of example 36 where the means for generating at least one application launch complete token may include: a means for receiving a second input at an activity manager circuit indicative that the application has successfully launched; a means for generating, by the activity manager circuit, an application successful message responsive to receipt of the second input; and a means for communicating the application successful message to the power control circuit.

Example 41 may include elements of example 40 where the means for generating, by the activity manager circuit, an application successful message responsive to receipt of the second input may include: a means for generating, by an ActivityManagerService, a WindowsVisible( ) message responsive to receipt of the second input.

Example 42 may include elements of example 36 where the means for generating, by the power control circuit, at least one application launch complete token may include: a means for generating, by a powerHAL wrapper layer the at least one successful launch token; a means for communicating the at least one successful launch token to a powerHAL layer; a means for generating a successful launch message at the powerHAL layer; and a means for communicating the successful launch message to a Linux kernel.

Example 43 may include elements of example 42 where the means for a means for transitioning the at least a portion of the system from the performance operating mode to a second normal operating mode may further include: a means for causing one or more kernel governors to decrease the operating frequency of the at least one of: a central processing unit (CPU); a graphical processing unit (GPU); or memory hardware from the second frequency to a third frequency responsive to receipt of the successful launch message at the Linux kernel.

Example 44 may include elements of example 30 where the means for transitioning the at least a portion of the system from the performance operating mode to a second normal operating mode may include: a means for transitioning the at least a portion of the system from the performance operating mode to a second normal operating mode, the second normal operating mode the same as the first normal operating mode.

According to example 45, there is provided a storage device that includes machine-readable instructions that, when executed by a configurable circuit, transform the configurable circuit to a system control circuit. The system control circuit to: cause a power control circuit to generate at least one application launch token responsive to a launch request for an application; transition at least a portion of the system from a first normal operating mode to a performance operating mode responsive to receipt of the at least one application launch token from the power control circuit; cause the power control circuit to at least one application launch complete token indicative of a successful launch of the application; and transition the portion of the system from the performance operating mode to a second normal operating mode responsive to receipt of the at least one application launch complete token.

Example 46 may include elements of example 45, where the machine-readable instructions that cause the system control circuit to transition at least a portion of the system from a first normal operating mode to a performance operating mode may further cause the system control circuit to increase an operating frequency of at least one of: a central processing unit (CPU); a graphical processing unit (GPU); or a data storage device from a first operating frequency to a second operating frequency.

Example 47 may include elements of example 46 where the machine-readable instructions that cause the system control circuit to transition the portion of the system from the performance operating mode to a second normal operating mode may further cause the system control circuit to decrease the operating frequency of the at least one of: the virtual machine; the GPU; or the data storage device from the second frequency to a third frequency by the system control circuit.

Example 48 may include elements of example 47 where the machine-readable instructions may further cause the system control circuit to: cause the power control circuit to initiate at least one timer having at least a first defined temporal threshold; and transition the at least a portion of the system from the performance operating mode to the first normal operating mode responsive to a failure to generate the at least one application launch complete token prior to the at least one timer reaching the first defined temporal threshold.

Example 49 may include elements of example 48 where the machine-readable instructions that cause the system control circuit to transition the portion of the system from the performance operating mode to a second normal operating mode may further cause the system control circuit to cause the power control circuit to generate a message that causes a decrease in the operating frequency of at least one of: the virtual machine; the GPU; or the data storage device from the second frequency to the first frequency.

Example 50 may include elements of example 48 where the machine-readable instructions that cause the system control circuit to cause the power control circuit to initiate at least one timer may further cause the system control circuit to cause the power control circuit to initiate the at least one timer contemporaneous with the generation of the at least one application launch token.

Example 51 may include elements of example 45 where the machine-readable instruction that cause the system control circuit to cause a power control circuit to generate at least one application launch token responsive to a launch request for an application may further cause the system control circuit to: receive a first input indicative of a request to launch the application at an activity manager circuit; cause the activity manager circuit to generate an application launch message responsive to receipt of the first input; and communicate the application launch message to the power control circuit.

Example 52 may include elements of example 51 where the machine-readable instructions that cause the system control circuit to cause the activity manager circuit to generate an application launch message responsive to receipt of the first input may further cause the system control circuit to cause an ActivityManagerService to generate a StartActivity( )message responsive to receipt of the first input.

Example 53 may include elements of example 52 where the machine-readable instructions that cause the system control circuit to cause a power control circuit to generate at least one application launch token responsive to a launch request for an application may further cause the system control circuit to: cause a powerHAL wrapper layer to generate the at least one application launch token; cause the powerHAL wrapper layer to communicate the at least one application launch token to a powerHAL layer; cause the powerHAL layer to generate an application launch message at the powerHAL layer; and cause the powerHAL layer to communicate the application launch message to a Linux kernel.

Example 54 may include elements of example 53 where the machine-readable instructions that cause the system control circuit to transition at least a portion of the system from a first normal operating mode to a performance operating mode may further cause the system control circuit to, responsive to receipt of the application launch message at the Linux kernel, cause one or more kernel governors to increase an operating frequency of at least one of: a central processing unit (CPU); a graphical processing unit (GPU); or a data storage device from a first frequency to a higher second frequency.

Example 55 may include elements of example 51 where the machine-readable instruction that cause the system control circuit to cause a power control circuit to generate at least one application launch token responsive to a launch request for an application may further cause the system control circuit to: cause an activity manager circuit to receive a second input indicative that the application has successfully launched; cause the activity manager circuit to generate an application successful message responsive to receipt of the second input; and communicate the application successful message to the power control circuit.

Example 56 may include elements of example 54 where the machine-readable instructions that cause the system control circuit to cause the activity manager circuit to generate an application successful message responsive to receipt of the second input may further cause the system control circuit instructions to: cause an ActivityManagerService to generate a WindowsVisible( ) message responsive to receipt of the second input.

According to example 57, there is provided a system for improving the load time of an application, the system being arranged to perform the method of any of examples 1 through 15.

According to example 58, there is provided a chipset arranged to perform the method of any of examples 1 through 15.

According to example 59, there is provided a machine readable medium comprising a plurality of instructions that, in response to be being executed on a computing device, cause the computing device to carry out the method according to any of examples 1 through 15.

According to example 60, there is provided a device configured for improving the load time of an application, the device being arranged to perform the method of any of examples 1 through 15.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A system for improving the load time of an application, the system comprising:
a power control circuit;
a system control circuit;
a storage device communicably coupled to the power control circuit and the system control circuit, the storage device including machine-readable instructions that, when executed:
cause the power control circuit to generate at least one application launch token responsive to receipt of an application launch request for the application;
cause the power control circuit to communicate the at least one application launch token to the system control circuit;
cause the system control circuit to transition at least a portion of the system from a first normal operating mode to a performance operating mode responsive to receipt of the first message from the power control circuit;
cause the power control circuit to generate at least one application launch complete token indicative of a successful launch of the application;
cause the power control circuit to communicate the at least one application launch complete token to the system control circuit; and
cause the system control circuit to transition the at least a portion of the system from the performance operating mode to a second normal operating mode responsive to receipt of the at least one application launch complete token.

2. The system of claim 1 wherein the machine-readable instructions that cause the system control circuit to transition at least a portion of the system from a first normal operating mode to a performance operating mode further cause the system control circuit to:
increase an operating frequency from a first operating frequency to a second operating frequency of at least one of: a virtual machine to execute the application; a graphical processing unit (GPU) to generate a display output for the application; or memory hardware that includes at least one of instructions or data used by the application.

3. The system of claim 2 wherein the machine-readable instructions that cause the system control circuit to transition the at least a portion of the system from the performance operating mode to the second normal operating mode further cause the system control circuit to:
decrease the operating frequency of the at least one of: the virtual machine; the GPU; or the memory hardware from the second frequency to a third frequency by the system control circuit.

4. The system of claim 3 wherein the machine-readable instructions further:
cause the power control circuit to initiate at least one timer having at least a first defined temporal threshold; and
responsive to a failure to generate the at least one application launch complete token prior to the at least one timer reaching the first defined temporal threshold, cause the system control circuit to transition the at least a portion of the system from the performance operating mode to the first normal operating mode.

5. The system of claim 4 wherein the machine-readable instructions that cause the system control circuit to transition the at least a portion of the system from the performance operating mode to the first normal operating mode further cause the system control circuit to:
decrease the operating frequency of at least one of: the virtual machine; the GPU; or the memory hardware from the second frequency to the first frequency.

6. The system of claim 4 wherein the machine-readable instructions that cause the power control circuit to initiate at least one timer further cause the power control circuit to initiate the at least one timer contemporaneous with the generation of the application launch token.

7. The system of claim 1 wherein the machine-readable instructions that cause the power control circuit to generate at least one application launch token cause the power control circuit to:
receive a first input indicative of a request to launch the application at an activity manager circuit;
cause the activity manager circuit to generate an application launch message responsive to receipt of the first input; and
cause the activity manager circuit to communicate the application launch message to the power control circuit.

8. The system of claim 7 wherein the machine-readable instructions that cause the activity manager circuit to generate an application launch message cause the activity manager circuit to:
cause an ActivityManagerService to generate a StartActivity( )message responsive to receipt of the first input.

9. The system of claim 8 wherein the machine-readable instructions that cause the power control circuit to generate at least one application launch token cause the power control circuit to:
cause a powerHAL wrapper layer to generate the at least one application launch token;
cause the powerHAL wrapper layer to communicate the at least one application launch token to a powerHAL layer;
cause the powerHAL layer to generate an application launch message; and
cause the powerHAL layer to communicate the application launch message to a Linux kernel.

10. The system of claim 9 wherein the machine-readable instructions that cause the system control circuit to transition at least a portion of the system from a first normal operating mode to a performance operating mode further cause the system control circuit to:
cause one or more kernel governors to increase the operating frequency of at least one of:
a central processing unit; a graphical processing unit; or memory hardware from the first operating frequency to the second operating frequency responsive to receipt of the application launch message at the Linux kernel.

11. The system of claim 7 wherein the machine-readable instructions that cause the power control circuit to generate at least one application launch complete token cause the power control circuit to:
cause the activity manager circuit to generate an application successful message responsive to receipt of a second input indicative that the application has successfully launched; and
cause the activity manager circuit to communicate the application successful message to the power control circuit.

12. The system of claim 11 wherein the machine-readable instructions that cause the activity manager circuit to generate an application successful message cause the activity manager circuit to:
cause an ActivityManagerService to generate a WindowsVisible( )message responsive to receipt of the second input.

13. The system of claim 7 wherein the machine-readable instructions that cause the power control circuit to generate at least one application launch complete token cause the power control circuit to:
cause a powerHAL wrapper layer to generate the at least one successful launch token;
cause the powerHAL wrapper layer to communicate the at least one successful launch token to a powerHAL layer;
cause the powerHAL layer to generate a successful launch message; and
cause the powerHAL layer to communicate the successful launch message to a Linux kernel.

14. The system of claim 13 wherein the machine-readable instructions that cause the system control circuit to transition the at least a portion of the system from the performance operating mode to a second normal operating mode cause the system control circuit to:
cause one or more kernel governors to decrease the operating frequency from the second operating frequency to the operating third frequency responsive to receipt of the successful launch message by the Linux kernel.

15. A method for improving load time of an application, the system comprising:
generating, by a power control circuit, at least one application launch token responsive to a launch request for an application;
transitioning, by a system control circuit, at least a portion of the system from a first normal operating mode to a performance operating mode responsive to receipt of the at least one application launch token from the power control circuit;
generating, by the power control circuit, at least one application launch complete token indicative of a successful launch of the application; and
transitioning, by the system control circuit, the at least a portion of the system from the performance operating mode to a second normal operating mode responsive to receipt of the at least one application launch complete token.

16. The method of claim 15 wherein transitioning at least a portion of the system from a first normal operating mode to a performance operating mode comprises:
increasing, by the system control circuit, an operating frequency of at least one of: a central processing unit (CPU); a graphical processing unit (GPU); or memory hardware from a first operating frequency to a second operating frequency.

17. The method of claim 16 wherein transitioning the at least a portion of the system from the performance operating mode to a second normal operating mode comprises:
decreasing the operating frequency of the at least one of: the virtual machine; the GPU;
or the memory hardware from the second frequency to a third frequency by the system control circuit.

18. The method of claim 17, further comprising:
initiating, by the power control circuit, at least one timer having at least a first defined temporal threshold; and
responsive to a failure to generate the at least one application launch complete token prior to the at least one timer reaching the first defined temporal threshold, transitioning the at least a portion of the system from the performance operating mode to the first normal operating mode.

19. The method of claim 18 wherein transitioning the at least a portion of the system from the performance operating mode to a first normal operating mode comprises:
generating, by the power control circuit, a message that causes the system control circuit to decrease the operating frequency of at least one of: the virtual machine; the GPU; or the memory hardware from the second frequency to the first frequency.

20. The method of claim 18 wherein initiating by the power control circuit at least one timer comprises:
initiating the at least one timer contemporaneous with the generation of the at least one application launch token by the power control circuit.

21. The method of claim 15 wherein generating at least one application launch token comprises:
receiving a first input at an activity manager circuit, the input indicative of a request to launch the application;
generating, by the activity manager circuit, an application launch message responsive to receipt of the first input; and
communicating the application launch message to the power control circuit.

22. The method of claim 21 wherein generating an application launch message responsive to receipt of the input indicative of the request to launch the application comprises:
generating a StartActivity( ) message by an ActivityManagerService responsive to receipt of the first input.

23. The method of claim 22 wherein generating at least one application launch token responsive to a launch request for an application comprises:
generating, by a powerHAL wrapper layer the at least one application launch token;
communicating the at least one application launch token to a powerHAL layer;
generating an application launch message at the powerHAL layer; and
communicating the application launch message to a Linux kernel.

24. The method of claim 23 wherein transitioning at least a portion of the system from a first normal operating mode to a performance operating mode comprises:
responsive to receipt of the application launch message at the Linux kernel, causing one or more kernel governors to increase an operating frequency of at least one of: a central processing unit (CPU); a graphical processing unit (GPU); or memory hardware from a first frequency to a higher second frequency.

25. A storage device that includes machine-readable instructions that, when executed by a configurable circuit, transform the configurable circuit to a system control circuit, the system control circuit to:
cause a power control circuit to generate at least one application launch token responsive to a launch request for an application;
transition at least a portion of the system from a first normal operating mode to a performance operating mode responsive to receipt of the at least one application launch token from the power control circuit;
cause the power control circuit to at least one application launch complete token indicative of a successful launch of the application; and
transition the portion of the system from the performance operating mode to a second normal operating mode responsive to receipt of the at least one application launch complete token.
